(19) United States
(12) Patent Application Publication
(10) Pub. No.: US 2017/0254466 A1
(43) Pub. Date: Sep. 7, 2017

(54) COUPLING APPARATUS FOR A FLOOR DRAIN AND METHOD OF USE

(71) Applicant: Christer Olsson, Victoria (CA)

(72) Inventor: Christer Olsson, Victoria (CA)

(21) Appl. No.: 15/447,464

(22) Filed: Mar. 2, 2017

(30) Foreign Application Priority Data
Mar. 3, 2016 (CA) 2922685

(51) Int. Cl. F16L 55/07; F16K 15/02; F16L 41/03

(52) U.S. Cl. CPC F16L 55/07; F16L 41/03; F16K 15/028

(57) ABSTRACT

A coupling apparatus for a floor drain which includes a hollow body having an exterior surface and an interior surface, with the interior surface defining a flow chamber. A primary inlet extends through the exterior surface of the body into the flow chamber; the primary inlet being of a first size to accommodate a drainage line from a hot water tank. At least one secondary inlet extends through the exterior surface of the body into the flow chamber. Each secondary inlet is of a second size, smaller than the primary inlet, in order to accommodate a smaller drainage line. A single outlet through the exterior surface of the body is provided for draining the flow chamber.

### FIELD

There is described a coupling apparatus used to connect a hot water tank to a floor drain.

### BACKGROUND

Every hot water tank has a drainage line. This drainage lines is laid along a floor with a remote end positioned immediately adjacent to a floor drain, so that any discharge through the drainage line will flow into the flow drain. In many installations, there are other appliances that also have drainage lines, such as humidifiers, air conditioners and some types of furnaces. It is, therefore, not unusual for there to be two or more drainage lines extending across the floor to the floor drain.

### SUMMARY

According to one aspect there is provided a coupling apparatus for a floor drain. The coupling apparatus includes a hollow body having an exterior surface and an interior surface, with the interior surface defining a flow chamber. A primary inlet extends through the exterior surface of the body into the flow chamber; the primary inlet being of a first size to accommodate a drainage line from a hot water tank. At least one secondary inlet extends through the exterior surface of the body into the flow chamber. Each secondary inlet is of a second size, smaller than the primary inlet, in order to accommodate a smaller drainage line. A single outlet is provided through the exterior surface of the body for draining the flow chamber.

According to another aspect there is provided a method of coupling a hot water tank to a floor drain using the coupling apparatus described above. The method involves connecting the outlet to a floor drain, connecting the primary inlet to a drainage line for a hot water tank and connecting the at least one secondary inlet to a drainage line from one of a humidifier, a furnace, an air handler or an air conditioner.

As will hereinafter be described, the use of the above described coupling apparatus provides a direction connection to the floor drain for improved functioning with improved aesthetics.

### BRIEF DESCRIPTION OF THE DRAWINGS

These and other features will become more apparent from the following description in Which reference is made to the appended drawings, the drawings are for the purpose of illustration only and are not intended to be in any way limiting, wherein:

FIG. 1 is a right side elevation view of a coupling apparatus for a floor drain.

FIG. 2 is a left side elevation view of the coupling apparatus of FIG. 1.

FIG. 3 is a rear elevation view of the coupling apparatus of FIG. 1.

FIG. 4 is a front elevation view of the coupling apparatus of FIG. 1.

FIG. 5 is a bottom plan view of the coupling apparatus of FIG. 1.

FIG. 6 is a top plan view of the coupling apparatus of FIG. 1.

FIG. 7, labelled as PRIOR ART, is a perspective view of a floor drain receiving multiple drainage lines.

FIG. 8 is a perspective view of the coupling apparatus of FIG. 1, with the primary inlet and one of the secondary inlets coupled to drainage lines.

FIG. 9 is a perspective view of the coupling apparatus of FIG. 1, with the primary inlet and two of the secondary inlets coupled to drainage lines.

FIG. 10 is a perspective view of the coupling apparatus of FIG. 1, with the primary inlet and three of the secondary inlets coupled to drainage lines.

FIG. 11 is a rear elevation view of the coupling apparatus of FIG. 1 with valve member, the valve member being in the closed position.

FIG. 12 is a rear elevation view of the coupling apparatus of FIG. 1 with valve member, the valve member being in the open position.

### DETAILED DESCRIPTION

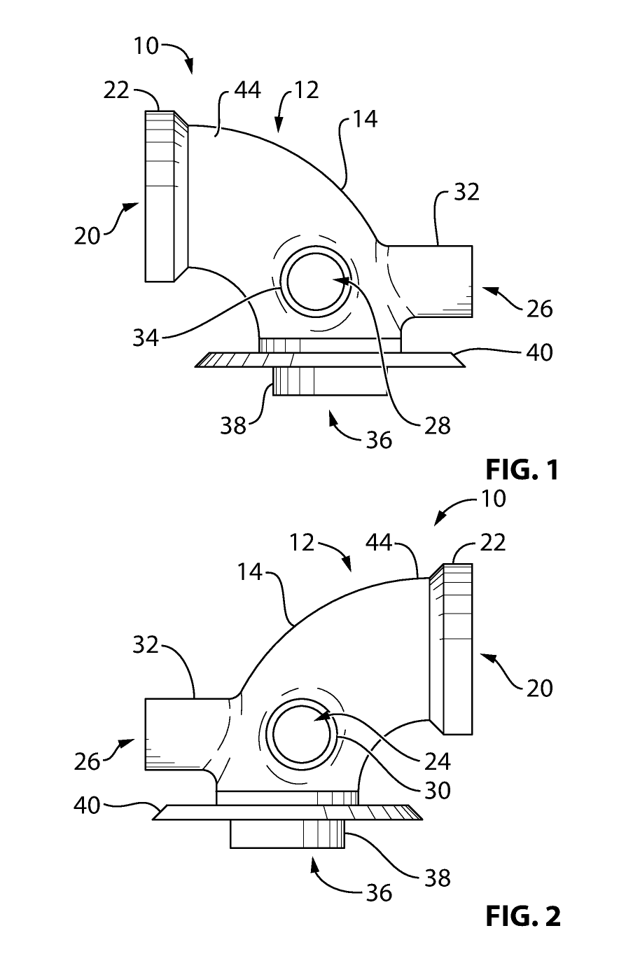

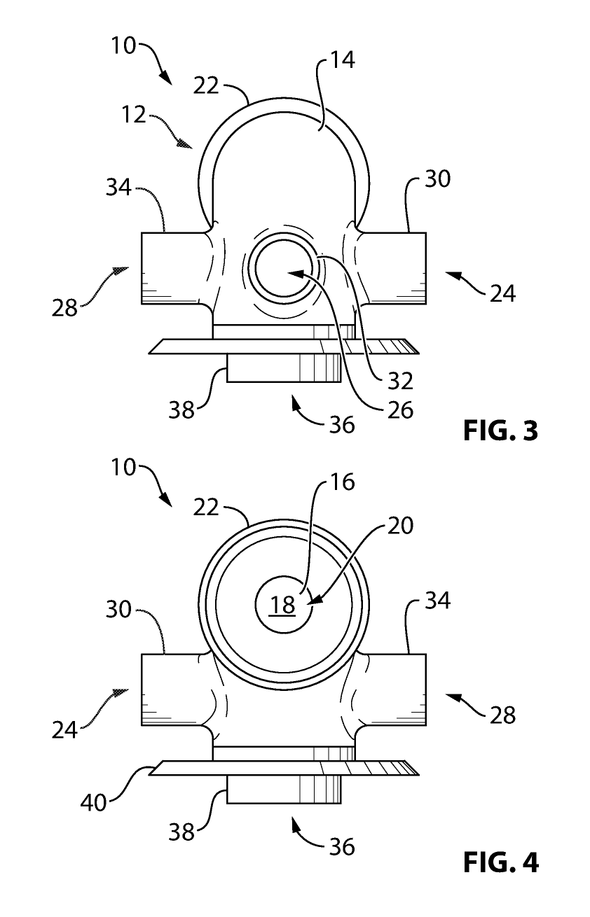

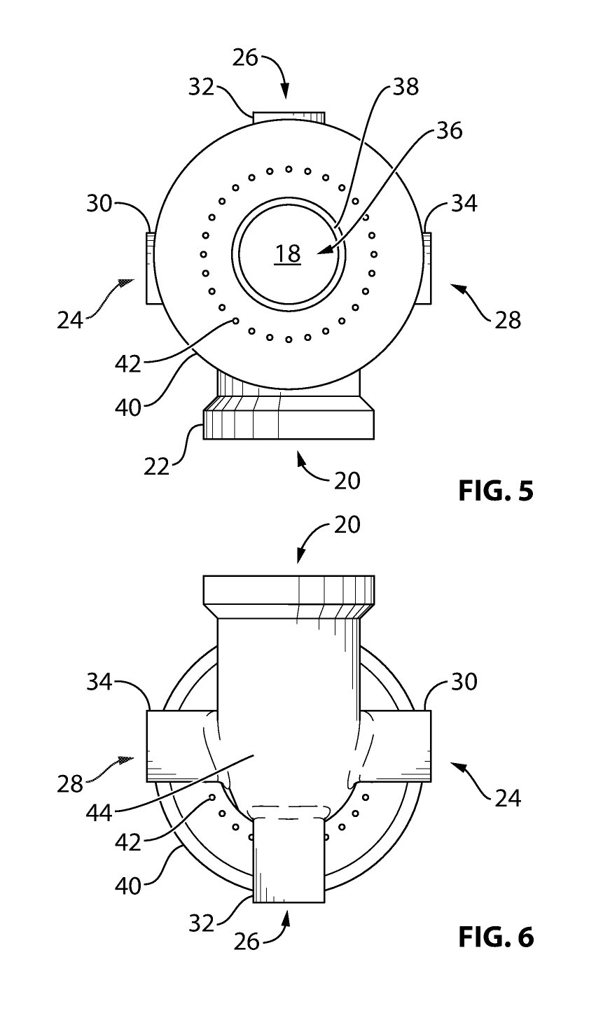

A coupling apparatus for a floor drain generally identified by reference numeral 10, will now be described with reference to FIG. 1 through 10.

### Structure and Relationship of Parts:

Referring to FIG. 1 through 6, coupling apparatus 10 consists of a hollow body 12 having an exterior surface 14 and an interior surface 16. Interior surface 16 defines a flow chamber 18. A primary inlet 20 extends through exterior surface 14 of body 12 into flow chamber 18. Primary inlet 20 is of a first size. This is to accommodate a drainage line from a hot water tank, as will hereinafter be described. A pipe coupling 22 for primary inlet 20 protrudes outwardly from body 12. Three secondary inlets 24, 26, and 28, respectively, extend through exterior surface 14 of body 12 into flow chamber 18. Each secondary inlet 24, 26, and 28 are of a second size, smaller than primary inlet 20, in order to accommodate a smaller drainage line as will hereinafter be further described. Each secondary inlet 24, 26, and 28 having a pipe coupling 30, 32, and 34, respectively, protrudes outwardly from body 12. A single outlet 36 extends through exterior surface 14 of body 12 for draining flow chamber 18. Outlet 36 has a pipe coupling 38 that protrudes outwardly from body 12. Pipe coupling 38 for outlet 36 has a circumferential floor engaging flange 40 with drainage holes 42.

Outlet 36 and flow chamber 18, can be considered to form a hub, generally indicated by reference numeral 44, with flow chamber 18 positioned above outlet 36 and with primary inlet 20 and secondary inlets 24, 26, and 28 extending radially from hub 44. To leave maximum room for attachment and accommodate drainage lines coming from different directions, couplings 20, 24, 26, and 28 are positioned in opposed relation, with respective pipe coupling 22 of primary inlet 20 and pipe couplings 30, 32, and 34 or secondary inlets 24, 26, and 28 forming a cross configuration. Due to difference in the size of drainage line to be accommodated, primary inlet 20 connects to huh 44 at a first height above outlet 36 and each of secondary inlets 24, 26, and 28 connect to hub 44 at a second height above outlet 36. The second height is less than the first height.

### Operation:

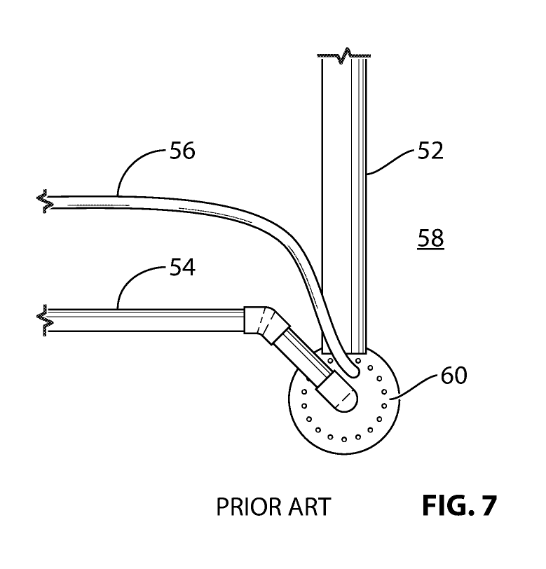

Referring to FIG. 7, there is illustrated a drainage line 52 originating from a hot water tank (not shown in this view), a drainage line 54 originating from an air conditioner (not shown in this view) and a drainage line 56 originating from a humidifier (not shown in this view). Each of drainage lines 52, 54 and 56 extend across a concrete floor 58, terminating at floor drain 60.

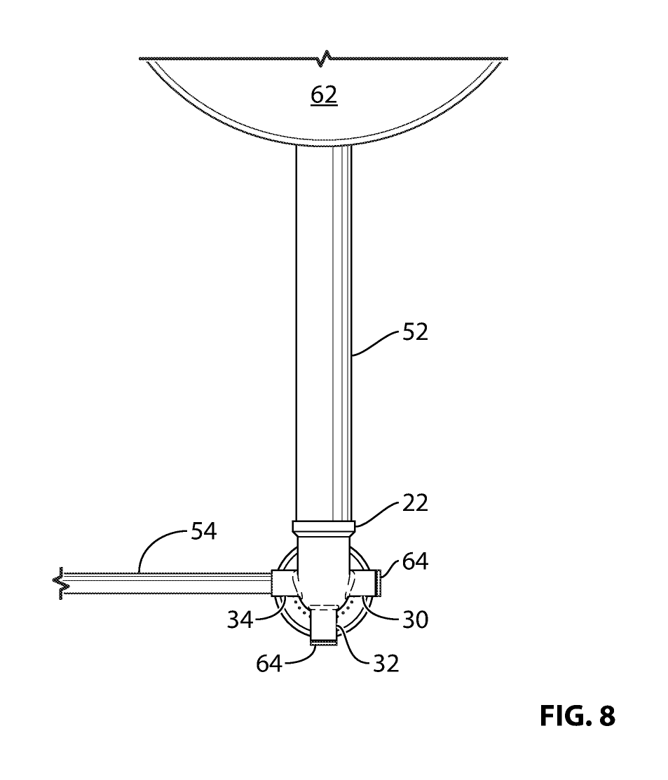

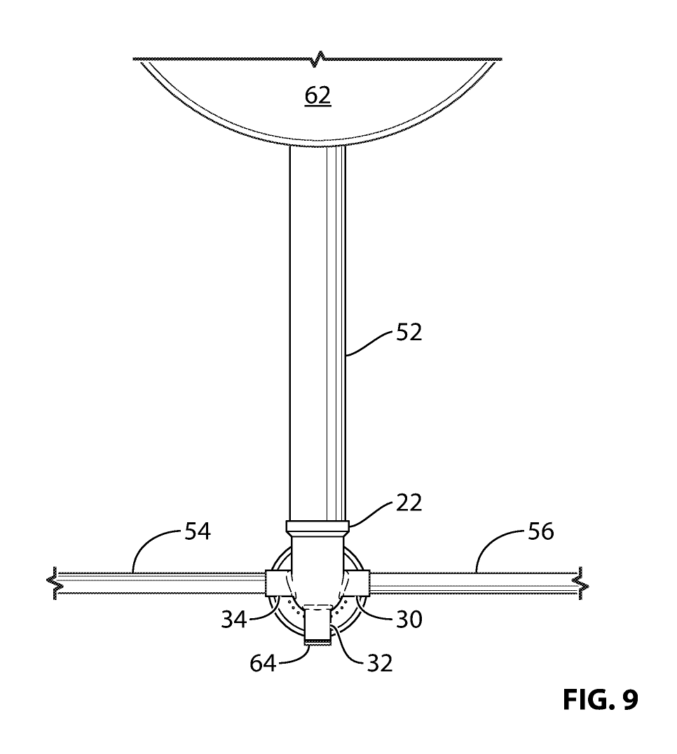

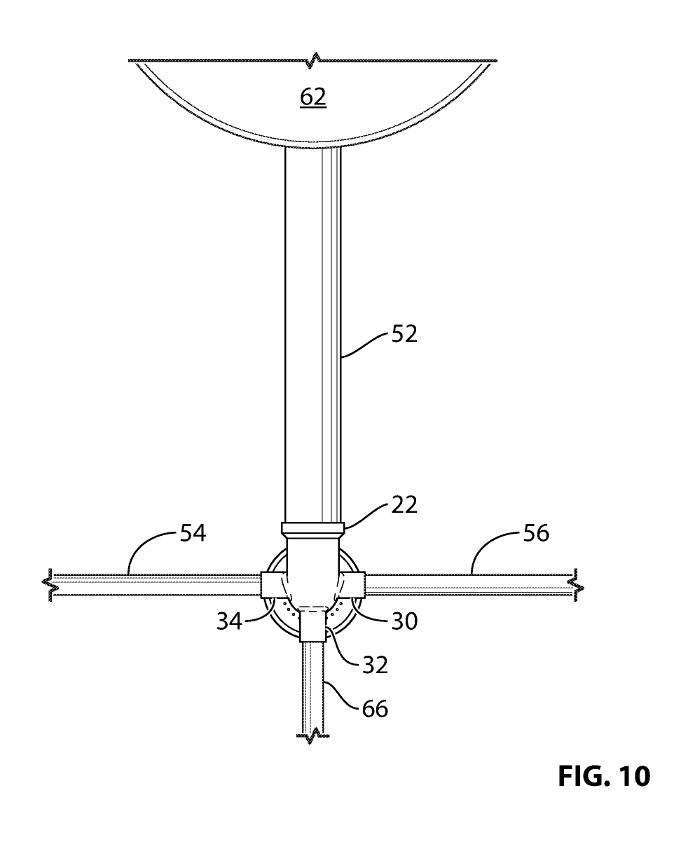

Referring to FIG. 8 through 10, there is illustrated connections made with coupling apparatus 10. Pipe coupling 38 of outlet 36 is inserted into floor drain 60. Flange 40 covers floor 58 along the edges of floor drain 60. The presence of drainage holes 42 in flange 40 allows water to pass through flange 40 into floor drain 60. Referring to FIG. 8, hot water tank 62 is shown with drainage line 52 extending from hot water tank 62 coupled with pipe coupling 22 of primary inlet 20 and drainage line 54 extending from the air conditioner (not shown) coupled with pipe coupling 34 of secondary inlet 28. Secondary inlets 24 and 26 are blocked with plugs 64 inserted into pipe couplings 30 and 32, respectively. Referring to FIG. 9, drainage line 56 from the humidifier (not shown) has been added to the configuration in FIG. 8, with drainage line 56 coupled with pipe coupling 30 of secondary inlet 24. Referring to FIG. 10, a further drainage line 66 from a furnace has been added to the configuration of FIG. 9, with drainage line 66 coupled with pipe coupling 32 of secondary inlet 26. In operation, any liquid flowing through any of drainage lines 52, 54, 56, or 66 enters flow chamber 18 in hub 44 and then exits through outlet 36 into floor drain 60. Coupling apparatus is not glued to floor 58, but is resting over floor drain 60 by force of gravity. This enables coupling apparatus 10 to be readily removed for the purpose of servicing floor drain 60, such as inserting a snake to clear any downstream blockage.

### Variations:

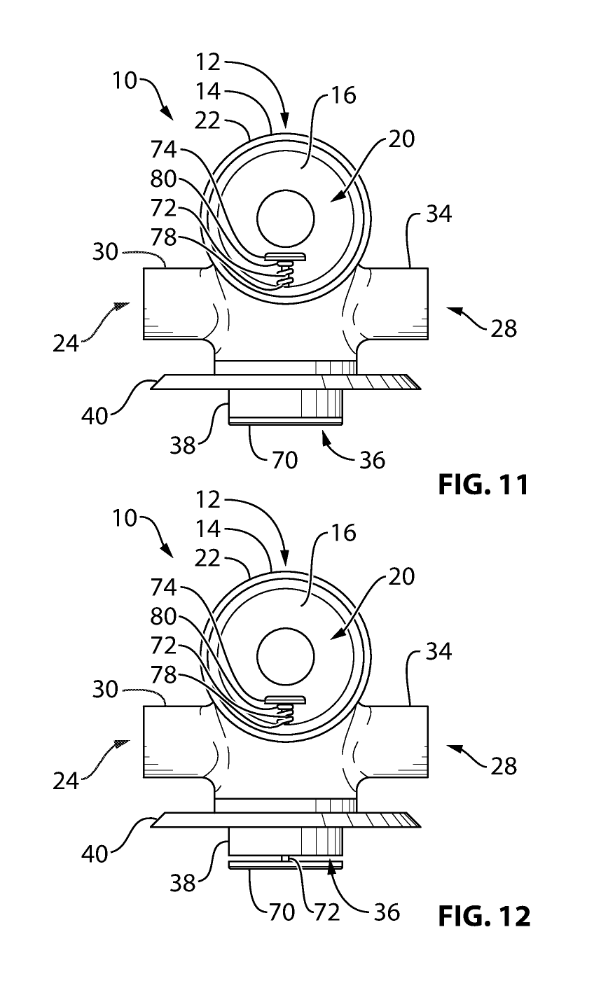

Referring to FIG. 11 and FIG. 12, the utility of coupling apparatus 10 can be enhanced by the addition of a valve member 70. Valve member 70 is movable relative to outlet 36 between a closed position illustrated in FIG. 11 and an open position illustrated in in FIG. 12. Referring to FIG. 11, in the closed position, valve member 70 obstructs outlet 36 and prevents liquid flow into or out of flow chamber 18 through outlet 36. Referring to FIG. 12, in the open position, valve member 70 is spaced from outlet 36 such that liquids are able to flow from flow chamber 18 from outlet 36 and passed valve member 70.

Referring to FIG. 11 and FIG. 12, a valve stem 72 extends perpendicularly from valve member 70. Valve stem 72 terminates in a stop shoulder 74. A biasing force is exerted upon valve member 70 by a spring 76. Spring 76 has a first end 78 and a second end 80. First end 78 engages interior surface 16 of body 12. Second end 80 engages stop shoulder 74. The force of spring 76 acts to push stop shoulder 74 away from interior surface 16 of body 12, which serves to bias valve member 70 into the closed position. This prevents a backflow from the drain from entering flow chamber 18. However, when water is flowing into flow chamber 18, the weight of the water and water pressure in flow chamber 18 of body 12 is sufficient to overcome the biasing force of spring 76 and move valve member 70 to the open position. With valve member 70 biased by spring 76, as described, flow can only be in one direction.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed:

1. A coupling apparatus for a floor drain, comprising:
a hollow body having an exterior surface and an interior surface, the interior surface defining a flow chamber;
a primary inlet through the exterior surface of the body into the flow chamber, the primary inlet being of a first size to accommodate a drainage line from a hot water tank;
at least one secondary inlet through the exterior surface of the body into the flow chamber, each secondary inlet being of a second size smaller than the primary inlet in order to accommodate a smaller drainage line; and
a single outlet through the exterior surface of the body for draining the flow chamber.

2. The coupling apparatus of claim 1, wherein a pipe coupling for the primary inlet protrudes outwardly from the body.

3. The coupling apparatus of claim 1, wherein each secondary inlet has a pipe coupling that protrudes outwardly from the body.

4. The coupling apparatus of claim 1, wherein a pipe coupling for the outlet protrudes outwardly from the body.

5. The coupling apparatus of claim 4, wherein the pipe coupling for the outlet has a circumferential floor engaging flange.

6. The coupling apparatus of claim 5, wherein the circumferential floor engaging flange has drainage holes.

7. The coupling apparatus of claim 1, wherein there are three secondary inlets.

8. The coupling apparatus of claim 7, wherein the outlet and flow chamber form a hub with the flow chamber positioned above the outlet and with the primary inlet and the three secondary inlets extending radially from the hub.

9. The coupling of claim 8, wherein each of the primary inlet and the three secondary inlets have pipe couplings that extend outwardly forming a cross configuration.

10. The coupling apparatus of claim 8, wherein the primary inlet connects to the hub at a first height above the outlet and each of the three secondary inlets connect to the hub at a second height above the outlet, the second height being less than the first height.

11. The coupling apparatus of claim 1, wherein a valve member is provided, the valve member being movable between a closed position and an open position relative to the outlet, in the closed position the valve member obstructs the outlet, and in the open position the valve member is spaced from the outlet such that liquids are able to flow from the outlet passed the valve member.

12. The coupling apparatus of claim 11, wherein a biasing force being exerted upon the valve member by a spring to bias the valve member into a normally closed position, until pressure in the flow chamber of the body is sufficient to overcome the biasing force of the spring to move the valve member to the open position.

13. A method of coupling a hot water tank to a floor drain, comprising:
providing a coupling apparatus for a floor drain, comprising:
a hollow body having an exterior surface and an interior surface, the interior surface defining a flow chamber;
a primary inlet through the exterior surface of the body into the flow chamber, the primary inlet being of a first size to accommodate a drainage line from a hot water tank;
at least one secondary inlet through the exterior surface of the body into the flow chamber, each secondary inlet being of a second size smaller than the primary inlet in order to accommodate a smaller drainage line; and
a single outlet through the exterior surface of the body for draining the flow chamber;
connecting the outlet to a floor drain;
connecting the primary inlet to a drainage line for a hot water tank;
connecting the at least one secondary inlet to a drainage line from one of a humidifier, a furnace, an air handler or an air conditioner.

14. A coupling apparatus for a floor drain, comprising:
a hollow body having an exterior surface and an interior surface, the interior surface defining a flow chamber;
a primary inlet through the exterior surface of the body into the flow chamber, the primary inlet being of a first size to accommodate a drainage line from a hot water tank, a pipe coupling for the primary inlet protrudes outwardly from the body;
three secondary inlets through the exterior surface of the body into the flow chamber, each secondary inlet being of a second size smaller than the primary inlet in order to accommodate a smaller drainage line, each secondary inlet having a pipe coupling that protrudes outwardly from the body; and
a single outlet through the exterior surface of the body for draining the flow chamber, the outlet having a pipe coupling that protrudes outwardly from the body, the pipe coupling for the outlet having a circumferential floor engaging flange with drainage holes, the outlet and flow chamber form a hub with the flow chamber positioned above the outlet and with the primary inlet and the three secondary inlets extending radially from the hub.

15. The coupling apparatus of claim 14, wherein the pipe couplings of the primary inlet and the three secondary inlets form a cross configuration.

16. The coupling apparatus of claim 14, wherein the primary inlet connects to the hub at a first height above the outlet and each of the three secondary inlets connect to the huh at a second height above the outlet, the second height being less than the first height.

17. The coupling apparatus of claim 14, wherein a valve member is provided, the valve member being movable between a closed position and an open position relative to the outlet, in the closed position the valve member obstructs the outlet and prevents liquid flow into or out of the flow chamber through the outlet, and in the open position the valve member is spaced from the outlet such that liquids are able to flow from the flow chamber from the outlet and passed the valve member, a biasing force being exerted upon the valve member by a spring to bias the valve member into a normally closed position, until pressure in the flow chamber of the body is sufficient to overcome the biasing force of the spring to move the valve member to the open position.
